(19) United States
(12) Patent Application Publication
(10) Pub. No.: US 2026/0245150 A1
(43) Pub. Date: Aug. 20, 2026

(54) MULTI-FACTOR DECISION DRIVEN ALGORITHM

(71) Applicant: ANAQUA INC, BOSTON, MA (US)

(72) Inventor: Vincent Brault, BOSTON, MA (US)

(73) Assignee: ANAQUA INC, BOSTON, MA (US)

(21) Appl. No.: 19/106,412

(22) PCT Filed: Aug. 12, 2023
(86) PCT No.: PCT/US23/72126

§ 371 Date: Feb. 25, 2025

(51) Int. Cl. G06Q 40/08; G06Q 50/18

(52) U.S. Cl. CPC G06Q 40/087; G06Q 50/184

(57) ABSTRACT

The present invention relates to a method for making a decision on intellectual property assets through a multi-factor decision driven algorithm, and in some embodiments acting on that decision. The algorithm may be based on internally and/or externally defined criteria, that may be predefined or may be updated on the fly based on said internally or externally defined criteria. The algorithm may then return a decision or set of decisions to a user wherein the user can choose to perform actions based on said decisions.

### BACKGROUND

The present disclosure relates generally to using an algorithm to help surface decisions based on various configurable factors, and more particularly to decision making for intellectual property issues based on said algorithm.

When it comes to decision making in intellectual property matters, there are a myriad of decisions that a legal or business professional has to make. These can be, but are not limited to, such items as whether to pay annuities on a particular asset or set of assets (such as a patent portfolio), where to file first, what foreign authorities to file in, etc. Often, these decisions are made very quickly, as there are many decisions to be made, and not enough time to look at all of the data available in-depth. IP professionals often have to make their “best guess” on the decision in a matter of seconds or minutes, and don't have the time to really study the asset in-depth.

### SUMMARY

Decisions are made every day that involve professionals looking at large amounts of data and based on that data, to make their best educated guess on the path forward. This data can take many forms and can include internal data sources or external data sources or both. Regardless, the decision makers are always looking for not only any data that can help them to make their decisions, but also how that data fits together and ways to increase the speed on those data decisions. Sometimes the decision maker only has a few seconds or minutes to make a decision that has the potential to make or lose a company millions of dollars or more.

Currently, most decisions are made either by using spreadsheets and a team or individual looking over that spreadsheet and trying to decide based on some knowledge and feelings about the data what to do with particular assets. Sometimes it is more of a gut feeling as to whether an asset meets the criteria. Too little information about an asset can lead to a rash decision because the person deciding can be missing some crucial information that might have swayed them to a different decision. Too much information can lead to errors in judgement just as easily as too little information, because someone may be overwhelmed with so much information they don't know what is the most important, or miss a particular data point, or one of many other human error factors.

This is where the concept of this multi-factor decision driven algorithm (hereafter “algorithm”) software comes into play. To give a leg up on the decision-making process, this algorithm is designed to help make the decision process more streamlined and easy for the decision makers, using more than one factor to help make the entire process for that decision maker, whatever the workflow or decision happens to be.

There are many facets to the data that can help the algorithm make that decision. Weighting and understanding that data, and building on other data, is important, and having an algorithm that can sort and determine based on best practices of the industry, competition, budget, roadmap, or any of a myriad of other data points that the decision driven algorithm can weight or discard or find as needed to at the very least provide feedback for the low hanging fruit, but even possibly for any of the more complex decisions that these professionals have to make.

### BRIEF DESCRIPTIONS OF THE DRAWINGS

FIG. 1 illustrates a pictorial representation of a network of data processing systems in which illustrative embodiments may be implemented;

FIG. 2 is a flowchart illustrating a process to input information to receive a decision based on the decision algorithm in accordance with an illustrative embodiment; and

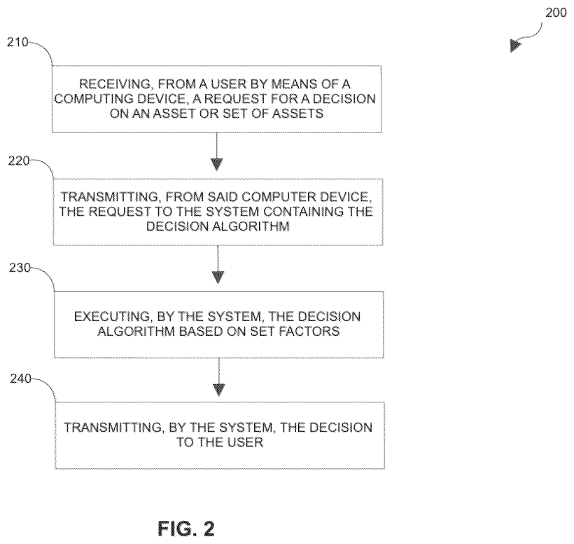

FIG. 3 is a flowchart illustrating a process to make a decision and facilitate additional action based on the decision algorithm in accordance with an illustrative embodiment.

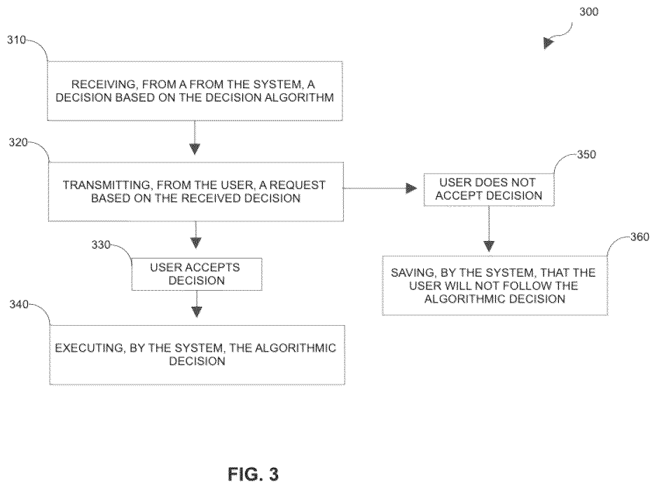

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

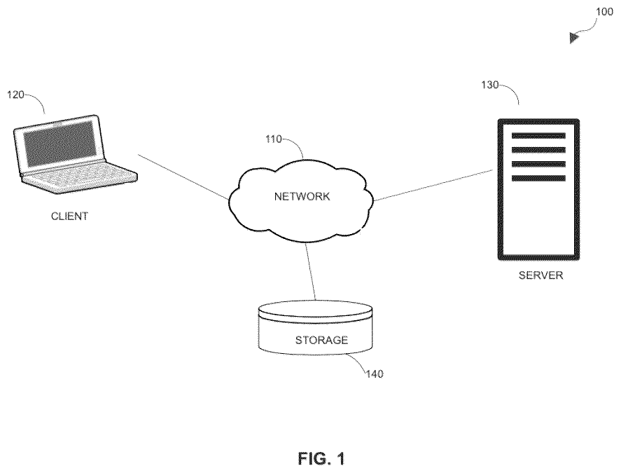

In the exemplary embodiment shown in FIG. 1, an intellectual property (hereafter “IP”) professional has to make a decision on a set of IP assets. In some embodiments, the IP professional may be an attorney, a paralegal, another member of the legal staff, a business manager that handles a portfolio, or other person that in some manner is required to make a decision on an IP asset. In some embodiments, the asset or assets in question may be a patent, trademark, trade secret, or something else that is understood as an asset by someone in the IP world.

In this embodiment, the IP professional is using the system 100 to help make the decisions faster. In this embodiment, the IP professional uses the client 120 to make a request of the algorithm through the network 110 to the server 130. The server 130 uses data either on itself, through network 110 to data on storage 140, or data stored on both itself and storage 140 to execute the decision algorithm on the request from the IP professional.

In some embodiments, data on storage 140 and server 130 may be internal data. In other embodiments, the data on storage 140 and server 130 may be external data. In still other embodiments, there may be a mix of internal and external data.

In some embodiments of FIG. 1, there may be more than one of either storage 140 or server 130 or both. In some exemplary embodiments, internal data, external data, or a mix of said data may be stored in one or multiple places and accessed by one or multiple server 130.

In one exemplary embodiment, an IP professional has to make the decision on a set of patents (hereafter “patent portfolio”) and whether the company should pay the annuities or maintenance fees on the patent portfolio. In this embodiment, the IP professional has only a few minutes per asset in the patent portfolio to make a decision, and has to make hundreds of decisions on one portfolio.

In this embodiment, the algorithm stored in server 130 has been keyed to specific data that the company has access to that is stored in storage 140. Each piece of data that has been determined to be useful to the company the IP professional works for has been added into the storage 140 and the decision algorithm in server 130 checks the data points and weights each data point at a specific weight depending on an expected business roadmap for the company. The IP professional, in this embodiment, has no access through client 120 to what those weights are. In some embodiments, the IP professional may have to input some or all of the data that the algorithm uses, such as which business roadmap the decision should be based on. In yet other embodiments, the IP professional has not put in any of the data that the algorithm uses. Regardless, in this embodiment, the IP professional requests through client 120 that the algorithm runs against a particular patent portfolio determined and input by the user.

In this exemplary embodiment, the algorithm determines that a certain percentage (for example, 20%) should have the annuities paid, and a certain percentage (for example, 30%) should be abandoned, and server 130 returns through network 110 to client 120 to display an indicator (for example, a green thumbs up for pay and a red thumbs down for abandon). For this example, the IP professional has worked with the software enough to trust the algorithm and clicks a selector to accept all the decisions returned. This acceptance is returned through network 110 to tell the algorithm or another program on server 130 to update the portfolio with the requested action. This then allows the IP professional to spend more time on the other 50% of the patent portfolio that was not as clear and was determined by the algorithm to require manual intervention and review.

In some related embodiments, the IP professional only selects some of the returned decisions and those accepted decisions are returned through network 110 to tell the algorithm or another program on server 130 to update the portfolio with the requested action. In some embodiments, the additional decisions that were not accepted are also updated to reflect that they were not accepted. In yet other embodiments, the additional decisions that were not accepted are ignored and no additional updates are performed by server 130.

In another exemplary embodiment, decisions have to be made on a set that is not limited to patents, such as, but not limited to, patents, trademarks, and trade secrets (hereafter “Portfolio”). In this embodiment, the algorithm has multiple sections of weights and data required for the different pieces of the Portfolio, since there may be different data points that are requested or required for different aspects of the Portfolio. In this embodiment, the IP professional, as well as one or more business professionals and other people in the company such as, but not limited to, financial analysts and outside legal counsel, have all worked together to determine the data points and the weighting for the various data points. Those data points are updated in the data stored in places such as server 130 or storage 140.

In this embodiment, the Portfolio may be determined automatically by such things as, but not limited to, dates, budget, business unit, manufacturing location, internal hierarchy, or people that will be joining the meeting where the decisions are made (for example, the subject matter experts, hereafter “SME,” that handle certain aspects of a Portfolio). In this exemplary embodiment, the algorithm is run and the percentage of decisions made by the algorithm are displayed for the decision makers to look over or select some, all, or none to be processed. For example, the algorithm may return a list of items that the decision has been made on where the decision makers can click one or all and then click to either perform or not perform an action such as, but not limited to, paying annuities or filing in a specific country. Once one decision has been made, any remaining items from said list may or may not be moved automatically back to the Portfolio for discussion or left to allow for selections and a next round of decisions on one or more items by the decision makers based off of the algorithm's findings and weightings.

In some embodiments, factors are market researched factors that are included in the base algorithm. For example, these market researched factors may include external data stored on storage 140 or in another, external storage device, about what competitors are doing in a particular technology. These may include such decisions as abandoning certain assets more often in one technology than in some other technology before paying maintenance fees on a particular patent or patents in the one technology, or shifting filing focus to certain technologies, countries, etc., or other decisions or strategies that are made by companies in a particular technology space. These external storage points may be accessed by server 130 on the fly to be used in the algorithm to make weighted determinations.

In still other embodiments, those external data points stored on a device such as storage 140 may be unknown to the IP professional and to the algorithm until such time as the IP professional uses client 120 to access the algorithm. In this embodiment, artificial intelligence (AI), machine learning (ML), or some other process may make a determination of what data points, either previously used, never used before, or some combination thereof, may be the best data points to make the decision requested through client 120. In such an embodiment, some data points may be previously determined, but other data points may be determined on the fly without prior settings or determination. These additional determining data points may be determined based on, but not limited to, scientific papers, white papers, competitor data, competitor business plans, user business plans, forecasting tools, budget, cognitive computing, etc.

In an exemplary embodiment, the algorithm is a learning algorithm that determines what factors to use to make the decision based on trends or other data available to it through internal and/or external data. For example, when created, the algorithm may be set to determine the best strategy for foreign filings for blocking a competitor. Based on this initial factor, the algorithm may then comb the available public data to determine that a competitor is poised to enter into a certain foreign market and return a decision to file in that market before the competitor. This decision may be returned because an IP professional has requested a decision on a set of assets, or may be returned because the algorithm is set to alert regardless of whether a user has requested use or not. In this example, the algorithm may run continuously or may be set to run at certain intervals to scan the available data points and return a decision regardless of whether or not there is a direct request from an IP professional or other user.

In some exemplary embodiments, factors are weighted depending on their forecasted effect on the portfolio. In one example, the algorithm determines that, due to a competitor's business decision, abandoning one of the assets submitted to the algorithm would save the company $20,000 over the life of the asset and would not affect sales. In this example, the algorithm would determine that the asset should be abandoned and return said decision to the IP professional. In another example, the algorithm determines that abandoning an asset would leave the company open to competitors and potentially lose $500,000 in sales for that year, and so the asset must be paid to retain market dominance. In yet another related example, the algorithm determines that filing a trademark in a particular country would allow sales in that country to continue without generics copying the particular product related to the trademark, and the decision returned is to file in that country as soon as possible to reduce competition risk.

Some embodiments will include all or some pieces of the above embodiments. Still other embodiments may include, but are not limited to, other types of decision makers, other types of data, such as budget, forecasting, market, or competitor data, other types of forms or decision trees, or other types of visual ques for the decision maker, such as, but not limited to, color coding, sorting, automatic shifting of all or certain pieces of the Portfolio to other new or previously created Portfolios, or automatic action by the algorithm depending on the findings of the algorithm.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, C #, or the like, and procedural programming languages, such as the “C” programming language or similar programming languages, or any other type of programming language such as Angular or ReactJS or others. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. It is also understood that the illustrations are in no ways meant to limit the invention, rather the illustrations are meant as only a few possible exemplary embodiments of the invention.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures, or may have other functions not shown added into the implementations. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A method comprising:
An algorithm;
That makes one or more decisions on an intellectual property asset or group of assets;
Based on internally defined data points, externally defined data points, or any combination;
That determines the one or more decisions on at least one predefined data points; and
Displays the one or more decisions to one or more user.

2. The method of claim 1:
Wherein the predefined data point or data points for the one or more decisions being updated after a user requests the one or more decision;
Wherein the predefined data point or data points are updated through a user, additional data, prior requested decisions by a user, such processes as AI or machine learning, or any combination.

3. The method of claim 1 further comprising:
A process by which a user can perform actions based on the algorithm's findings to update said asset or group of assets.

4. The method of claim 1:
Wherein the algorithm determines whether annuities or maintenance fees should be paid on said asset or group of assets.

5. The method of claim 1:
Wherein the algorithm weighs each data point or data points based on one or more of an expected business roadmap for the company, costs, budget, manufacturing location, market factors, comments from internal meetings, or a combination thereof.

6. The method of claim 1:
Wherein the algorithm weighs each data point or data points based on forecasted effects on the portfolio.

7. The method of claim 1:
Wherein the algorithm determines a percentage of decisions to be made on the asset or group of assets.

8. A system comprising:
A processor; and
A memory in communication with the processor, the memory containing program instructions that, when executed by the processor, are configured to cause the processor to perform a method, the method comprising:
An algorithm;
That makes one or more decisions on an intellectual property asset or group of assets;
Based on internally defined data points, externally defined data points, or any combination;
That determines the one or more decisions on at least one predefined data points; and
Displays the one or more decisions to one or more user.

9. The system of claim 8:
Wherein the predefined data point or data points for the one or more decisions being updated after a user requests the one or more decision;
Wherein the predefined data point or data points are updated through a user, additional data, prior requested decisions by a user, such processes as AI or machine learning, or any combination.

10. The system of claim 8 wherein the method further comprises:
A process by which a user can perform actions based on the algorithm's findings to update said asset or group of assets.

11. The system of claim 8:
Wherein the algorithm determines whether annuities or maintenance fees should be paid on said asset or group of assets.

12. The system of claim 8:
Wherein the algorithm weighs each data point or data points based on one or more of an expected business roadmap for the company, costs, budget, manufacturing location, market factors, comments from internal meetings, or a combination thereof.

13. The system of claim 8:
Wherein the algorithm weighs each data point or data points based on forecasted effects on the portfolio.

14. The system of claim 8:
Wherein the algorithm determines a percentage of decisions to be made on the asset or group of assets.

15. A computer program product comprising:
One or more computer readable storage media and program instructions stored on the one or more computer readable storage media, the stored program instructions comprising:
An algorithm;
That makes one or more decisions on an intellectual property asset or group of assets;
Based on internally defined data points, externally defined data points, or any combination;
That determines the one or more decisions on at least one predefined data points; and
Displays the one or more decisions to one or more user.

16. The computer program product of claim 15:
Wherein the predefined data point or data points for the one or more decisions being updated after a user requests the one or more decision;
Wherein the predefined data point or data points are updated through a user, additional data, prior requested decisions by a user, such processes as AI or machine learning, or any combination.

17. The computer program product of claim 15, wherein the program instructions, stored on the one or more computer readable storage media, further comprises:
A process by which a user can perform actions based on the algorithm's findings to update said asset or group of assets.

18. The computer program product of claim 15:
Wherein the algorithm determines whether annuities or maintenance fees should be paid on said asset or group of assets.

19. The computer program product of claim 15:
Wherein the algorithm weighs each data point or data points based on one or more of an expected business roadmap for the company, costs, budget, manufacturing location, market factors, comments from internal meetings, or a combination thereof.

20. The computer program product of claim 15:
Wherein the algorithm weighs each data point or data points based on forecasted effects on the portfolio.
